(19) United States
(12) Patent Application Publication
(10) Pub. No.: US 2020/0042728 A1
(43) Pub. Date: Feb. 6, 2020

(54) INFORMATION PROCESSING APPARATUS AND INFORMATION PROCESSING METHOD

(71) Applicant: Bank Invoice Corporation, Tokyo (JP)

(72) Inventor: Taro Teshima, Tokyo (JP)

(21) Appl. No.: 16/600,560

(22) Filed: Oct. 13, 2019

Related U.S. Application Data
(63) Continuation of application No. PCT/JP2018/004751, filed on Feb. 9, 2018.

(30) Foreign Application Priority Data
Apr. 14, 2017 (JP) 2017080625

(51) Int. Cl. G06F 21/62; G06Q 10/10

(52) U.S. Cl. CPC G06F 21/6209; G06Q 10/107

(57) ABSTRACT

An information management apparatus includes: a management data storage unit that stores therein a basic data management table in which, when business document data sent from a terminal device to a specified recipient is received over a network, the received business document data is stored in association with identification information of the recipient and identification information of the sender of the business document data and a deletion data management table that contains a condition for making at least partial data of the business document data inaccessible to the recipient; and a data processing unit that makes, when the sender or recipient takes an action defined in the condition set in the deletion data management table, at least the partial data of the business document data inaccessible to the recipient.

### CROSS-REFERENCE TO RELATED APPLICATION

This application is a continuation application of International Application PCT/JP2018/004751 filed on Feb. 9, 2018, designating the U.S. and claiming priority from Japanese Patent Application No. 2017-080625 filed on Apr. 14, 2017. The entire contents of both foregoing applications are incorporated herein by reference.

### BACKGROUND

### FIELD

The embodiment discussed herein relates to an information processing apparatus and an information processing method.

There is known a technique for achieving unified management for viewing of business documents (for example, documents and others) of an entire company or an entire corporate group and information thereof.

For example, there is known an information processing apparatus that has a first storage unit that stores therein user information associating, for each user, user identification information identifying the user and at least one piece of unique information with the user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

Consider, for example, the case of managing data you do not wish to be made available to the public, such as personal information and trade secret (hereinafter, such data is referred to as confidential data).

For example, consider the case where a clinic carries out a medical checkup and requests analysis of blood and urine samples to a medical diagnostic company.

To reduce the risk of leaking personal information, the medical diagnostic company may desire to delete confidential data indicating the analysis results after completing the analysis and reporting the confidential data to the clinic. For this reason, such confidential data may be deleted after a certain period of time.

Here, manual deletion of confidential data has a risk of leaking a confidential document, forgetting the confidential data, and a risk of deleting data that needs to be kept by mistake.

### SUMMARY

According to one aspect, there is provided an information management apparatus, including: a first memory configured to store therein, upon receipt of business document data sent from a terminal device to a specified recipient over a network, the received business document data in association with identification information of the recipient and identification information of a sender of the business document data; a second memory configured to store therein a condition for making at least partial data of the business document data inaccessible to the recipient; and a processor configured to perform a process of making the at least partial data of the business document data inaccessible to the recipient upon detecting that the sender or the recipient has taken an action defined in the condition set in the second memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an information management system according to one embodiment.

FIG. 2 is a view for explaining an example of a screen that is displayed on a terminal device after a login.

FIG. 3 is a view for explaining an example of a screen that is displayed on the terminal device.

FIG. 4 illustrates a hardware configuration of an information management apparatus according to the embodiment.

FIG. 5 is a block diagram illustrating functions of the information management apparatus according to the embodiment.

FIG. 6 is a view for explaining an example of basic data.

FIG. 7 is a view for explaining an example of text data.

FIG. 8 is a view for explaining an example of attached data.

FIG. 9 is a view for explaining an example of deletion data.

FIG. 10 is a view for explaining information to be displayed in a summary display area.

FIG. 11 is a view for explaining another example of a screen that is displayed on the terminal device.

FIGS. 12A and 12B are views for explaining information to be displayed in the summary display area.

FIGS. 13 and 14 are views for explaining how a data deletion unit operates.

FIG. 15 is a view for explaining a management screen that is viewed by staff of a clinic.

FIG. 16 is a flowchart illustrating a process that is performed in creation of confidential data.

FIG. 17 is a flowchart illustrating a process of managing deletion data.

FIG. 18 is a flowchart illustrating a process that is performed in deletion of data.

FIG. 19 is a view for explaining a management screen that is viewed by staff of a clinic according to a modification example.

FIG. 20 illustrates an example of external communication data.

FIGS. 21 and 22 illustrate examples of an external communication list.

### DESCRIPTION OF EMBODIMENTS

Hereinafter, an information management system according to an embodiment will be described in detail with reference to the accompanying drawings.

(Embodiment)

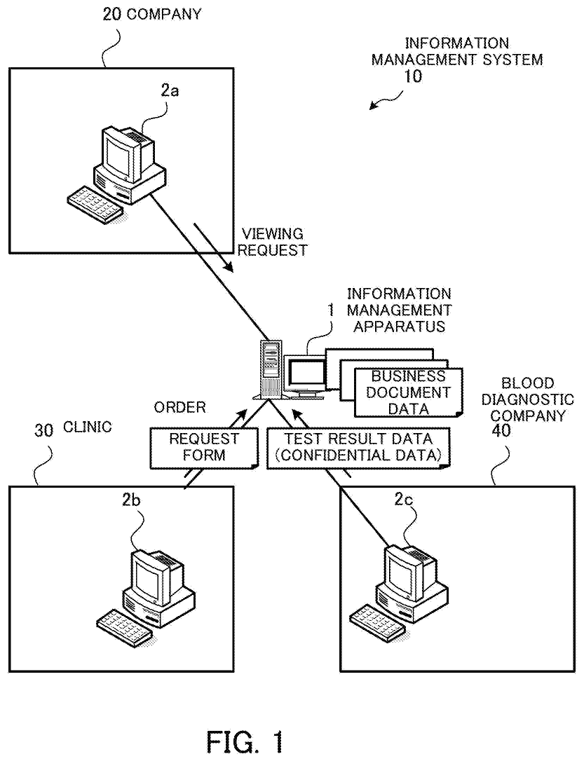

FIG. 1 illustrates an information management system according to one embodiment.

In the information management system 10 of the embodiment, an information management apparatus 1 is connected to terminal devices 2a, 2b, and 2c over the Internet or a dedicated network.

The following describes an example where a company 20, a clinic 30 that carries out health checkup for employees of the company 20, and a blood diagnostic company 40 communicate information with each other. The clinic 30 takes blood samples from the employees as part of the health checkup, and the blood diagnostic company 40 analyzes the blood samples.

The terminal device 2a is placed at the company 20. The terminal device 2b is placed at the clinic 30. The terminal device 2c is placed at the blood diagnostic company 40.

Examples of the terminal devices 2a, 2b, and 2c include desktop personal computers (PC), laptop PC, tablet terminals, and smartphones.

A web program is installed in the information management apparatus 1 and the terminal devices 2a, 2b, and 2c. The terminal devices 2a, 2b, and 2c communicate business-related document data (hereinafter, referred to as business document data) with the information management apparatus 1.

Examples of business document data include cover letters, request forms, estimate forms, order forms, and invoices.

In the following description, it is assumed that the information management system 10 is used by individual staff of the company 20, clinic 30, and blood diagnostic company 40.

Each staff of the company 20, clinic 30, and blood diagnostic company 40 performs user registration to the information management apparatus 1 using an assigned Email address or the like, in order to set up a connection to an information processing system provided by the information management apparatus 1.

After that, for example, the staff of the clinic 30 operates the terminal device 2b to display a login screen provided by the information management apparatus 1 on a monitor connected to the terminal device 2b. The staff enters his/her mail address and password on the login screen, thereby logging in to the service provided by the information management apparatus 1. In this connection, the mail address is an example of identification information identifying the staff. Examples to identify the staff include vein authentication and fingerprint authentication.

After the login, the individual staff are able to operate their terminal devices 2a, 2b, and 2c to communicate with each other via the information management apparatus 1. Examples of the communication include creation, sending, receipt, viewing, and editing of business document data.

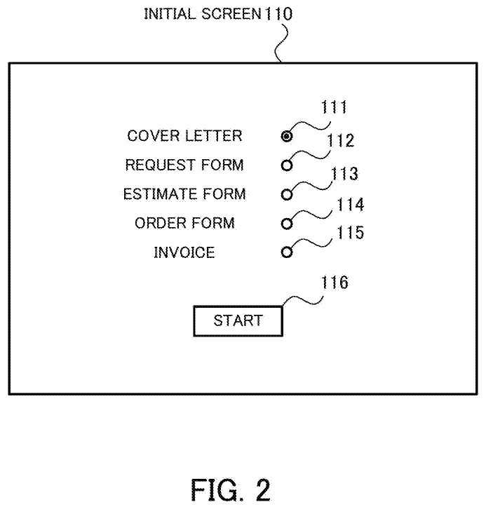

FIG. 2 is a view for explaining an example of a screen that is displayed on a terminal device after a login.

As an example, FIG. 2 illustrates an initial screen 110 that is displayed on the terminal device 2b after the staff of the clinic 30 logs in to the system.

The initial screen 110 has check boxes 111 to 115 for selecting a document to be created (cover letter, request form, estimate form, order form, and invoice) and a Start button 116. It is needless to say that the types of documents to be created are not limited to those illustrated in FIG. 2

When the staff selects a check box on the initial screen 110 and presses the Start button 116, a screen (management screen) for creating a document specified by the selected check box appears on the terminal device 2b.

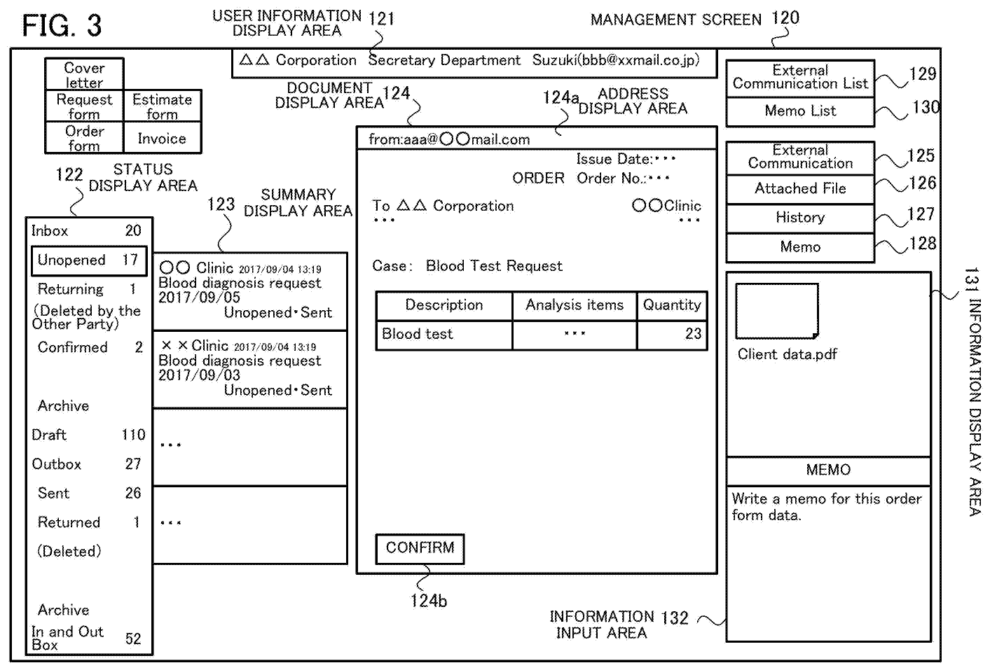

FIG. 3 is a view for explaining an example of a screen that is displayed on the terminal device.

As an example, FIG. 3 illustrates a management screen 120 of FIG. 3 that is displayed on the terminal device 2b when the staff of the clinic 30 selects the check box 114 (order form).

The management screen 120 will be described in detail later. Here, a simple explanation thereof will be provided.

As illustrated in FIG. 3, the staff is able to create, issue, view, and edit order form data in a document display area 124, like he/she uses mail software. Also, the staff is able to attach an attached file, by using an information input section 132 or by selecting an Attached File button 126.

For example, when the staff of the clinic 30 requests an analysis of a blood sample to the blood diagnostic company 40, the staff operates the terminal device 2b to create a request form with the blood diagnostic company 40 designated as a recipient on the management screen displayed after a login. Then, the staff sends the data of the created request form addressed to the mail address (bbb@xxmail.co.jp) of the staff (recipient) of the blood diagnostic company 40. The sent request form data is held by the information management apparatus 1.

That is, data is not communicated directly between the terminal devices 2a, 2b, and 2c. Rather, all data created by the terminal devices 2a, 2b, and 2c and sent to recipients is held by the information management apparatus 1. The data is treated like shared data. The information management apparatus 1 gives viewing and editing authorities for the data to the terminal devices 2a, 2b, and 2c according to necessity. In this connection, the information management apparatus 1 may be designed to manage such data over the Internet via cloud computing.

The above approach makes it possible to digitize and process the originals electronically, which leads to saving labor for management and storage of paper- or PDF-based data.

As described earlier, data is not communicated directly between the terminal devices 2a, 2b, and 2c. In the following description, however, in the case where request form data addressed to the mail address of the staff of the blood diagnostic company 40 is sent from the staff of the clinic 30, for example, an expression like “the staff receives the request form data” may be used, as in the general communication of data, for easy understanding.

In this connection, it is preferable that data be communicated in an encrypted form between the information management apparatus 1 and each terminal device 2a, 2b, and 2c.

Refer now back to FIG. 1.

By the way, business document data includes data that is open to the public and data (confidential data) that a data creator does not wish to be available to the public.

Confidential data is not limited to any specific data. Examples of confidential data include data indicating an amount of money, such as estimate forms, sales order forms, and invoices, and personal information on people, such as data indicating blood test result (blood test result data) to blood tests of employees of the company 20, medical charts, and prescriptions.

In the embodiment, the staff of the blood diagnostic company 40 is able to designate deletion target data in business document data, to thereby create confidential data.

More specifically, the staff of the blood diagnostic company 40 sends test result data (confidential data) addressed to the mail address (aaa@oomail.com) of staff (recipient) of the clinic 30, with blood test result data attached. At this time, the staff of the blood diagnostic company 40 sets a condition where, if a certain action condition is satisfied, the test result data is made inaccessible to the staff of the clinic 30.

The information management apparatus 1 stores the test result data in association with the mail address of the staff of the clinic 30 and the mail address of the staff of the blood diagnostic company 40 that has sent the test result data.

Then, when the staff of the blood diagnostic company 40 or clinic 30 takes an action defined in the action condition preset by the staff of the blood diagnostic company 40, the information management apparatus 1 performs a process of making at least partial data of the blood test data inaccessible to the staff of the clinic 30.

Now, the disclosed information management system will be described more concretely.

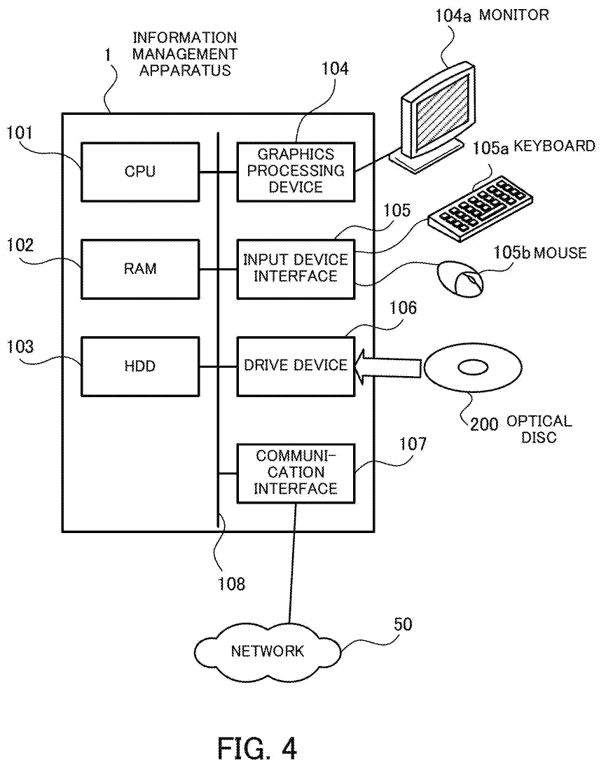

FIG. 4 illustrates a hardware configuration of the information management apparatus according to the present embodiment.

The information management apparatus 1 is entirely controlled by a central processing unit (CPU) 101. A random access memory (RAM) 102 and a plurality of peripheral devices are connected to the CPU 101 via a bus 108.

The RAM 102 is used as a main storage device of the information management apparatus 1. The RAM 102 temporarily stores therein at least part of operating system (OS) programs and application programs that are executed by the CPU 101. In addition, the RAM 102 stores therein various kinds of data to be used by the CPU 101 in processing.

Connected to the bus 108 are a hard disk drive (HDD) 103, a graphics processing device 104, an input device interface 105, a drive device 106, and a communication interface 107.

The HDD 103 magnetically writes and reads data on a built-in disk. The HDD 103 is used as an auxiliary storage device of the information management apparatus 1. The OS programs, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a cathode ray tube (CRT) display and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a universal serial bus (USB) memory. For example, in the case where the drive device 106 is an optical drive device, data recorded on an optical disc 200 may be read with laser light or the like. Examples of the optical disc 200 include a Blu-ray (registered trademark), a digital versatile disc (DVD), a DVD-RAM, a compact disc read only memory (CD-ROM), a compact disc recordable (CD-R), and a compact disc rewritable (CD-RW).

The communication interface 107 is connected to a network 50. The communication interface 107 communicates data with another computer or communication device over the network 50.

With the above hardware configuration, the processing functions of the present embodiment may be implemented. In this connection, FIG. 4 illustrates a hard configuration of the information management apparatus 1. The other computers including the terminal device 2a may be implemented with the same hardware configuration as the information management apparatus 1.

The information management apparatus 1 having the hardware configuration illustrated in FIG. 4 has the following functions.

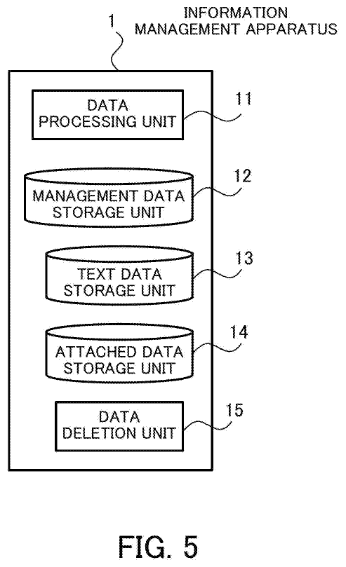

FIG. 5 is a block diagram illustrating functions of the information management apparatus according to the present embodiment.

The information management apparatus 1 has a data processing unit 11, a management data storage unit 12, a text data storage unit 13, an attached data storage unit 14, and a data deletion unit 15.

The data processing unit 11 displays the initial screen 110 illustrated in FIG. 2 and the management screen 120 illustrated in FIG. 3 on the terminal device 2b or the like in accordance with operations made by staff. The data processing unit 11 performs appropriate processing according to operations made to business document data on the management screen 120. For example, the data processing unit 11 stores data relating to staff and others in business document data received by the information management apparatus 1 in the management data storage unit 12.

The management data storage unit 12 stores therein data (hereinafter, referred to as management data) for managing business document data received by the information management apparatus 1.

The management data includes basic data on staff, the sending and receiving status of data, and others, text data on the contents of order forms and cover letters, attached data on attached files, and deletion data to be used for deleting text data and attached data. The following describes examples.

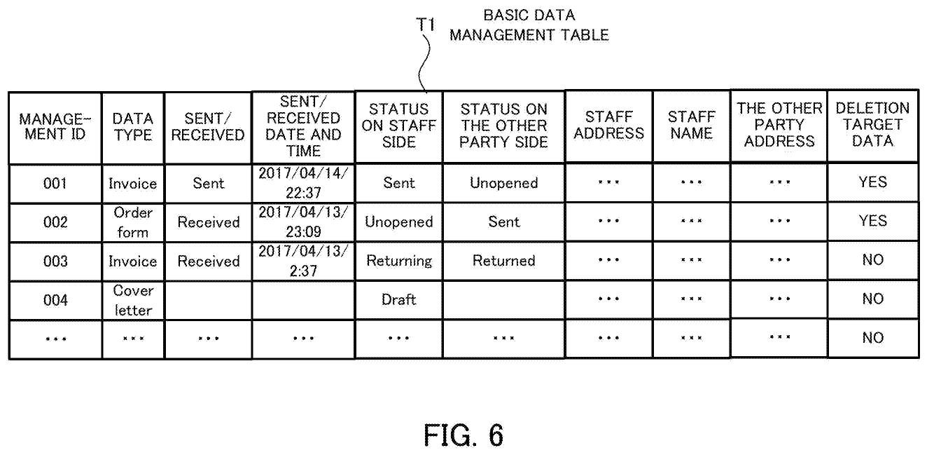

FIG. 6 is a view for explaining an example of basic data.

In the present embodiment, basic data is stored in tabular form.

The basic data management table T1 has the following columns: Management ID, Data Type, Sent/Received, Sent/Received Date and Time, Status on Staff Side, Status on the Other Party Side, Staff Address, Staff Name, The Other Party Address, and Deletion Target Data. Information pieces arranged in horizontal direction are associated with each other.

The Management ID column contains an ID unique to basic data for use in management of the basic data. When the information management apparatus 1 receives business document data, the data processing unit 11 gives a management ID to the received business document data.

The Sent/Received column indicates whether the business document data is data that has been received or sent, in view of staff. More specifically, “Received” indicates that the data is received data, whereas “Sent” indicates the data is sent data.

The Sent/Received Date and Time column contains the latest date and time among dates and times when the business document data was sent and received.

The Status on Staff Side column indicates the status (processing progress) of the business document data in view of the staff.

The Status on the Other Party Side column indicates the status of confidential data in view of the staff of the other party that communicates the business document data.

The statuses to be set in the Status on Staff Side and Status on the Other Party Side columns include the following: “Unopened,” “Returning,” “Confirmed,” “Paid,” “Archive,” “Sent,” and “Returned.” These statuses will be described in detail later.

The Staff Address column contains the mail address of the staff.

The Staff Name column contains the department to which the staff belongs and the name of the staff.

The Other Party Address column contains the mail address of the staff of the other party that communicates the business document data.

The Deletion Target Data column contains information indicating whether deletion target data is designated in the business document data.

In addition to the above-described information, the basic data management table T1 contains information about the company name of the staff, the company name of the staff of the other party that communicates the business document data, the postal codes and addresses of both companies, departments, and others.

In this connection, in the present embodiment, all business document data is managed using one basic data management table T1. Alternatively, such a table may be created for each data type.

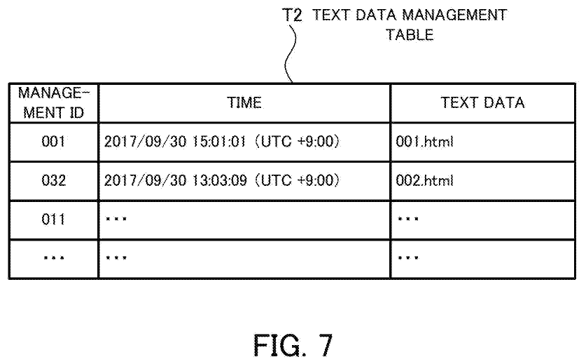

FIG. 7 is a view for explaining an example of text data.

In the present embodiment, text data is recorded in tabular form.

The text data management table T2 has the following columns: Management ID, Time, and Text Data. Information pieces arranged in horizontal direction are associated with each other.

The Management ID column contains the management ID of business document data (business document data associated with text data).

The Time column contains the creation date and time of the text data (more specifically, the date and time when a Send button, to be described later, was selected).

The Text Data column contains the name of the text data. In the case where the text data is a collection of divided data items, the names of the divided data items are recorded.

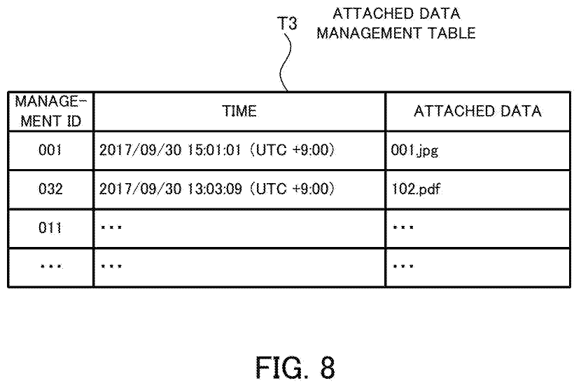

FIG. 8 is a view for explaining one example of attached data.

In the present embodiment, attached data is recorded in tabular form.

The attached data management table T3 has the following columns: Management ID, Time, and Attached Data. Information pieces arranged in a horizontal direction are associated with each other.

The Management ID column contains the management ID of business document data displayed on a screen at the time of attachment of attached data. In this connection, examples of the attached data include an image, a medium, a document, and a contact destination.

The Time column contains the date and time of attachment of the attached data.

The Attached Data column contains the name of the attached data.

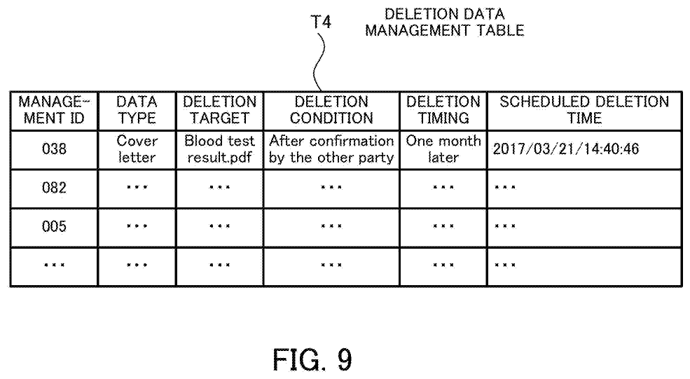

FIG. 9 is a view for explaining an example of deletion data.

In the present embodiment, deletion data is recorded in tabular form.

The deletion data management table T4 has the following columns: Management ID, Data Type, Deletion Target, Deletion Condition, Deletion Timing, and Scheduled Deletion Time. Information pieces arranged in a horizontal direction are associated with each other.

The Data Type column contains the type of business document data including deletion target data.

The Deletion Target column contains the name identifying the deletion target data (in FIG. 9, the name of attached data).

The Deletion Condition column contains a deletion condition set by staff.

The Deletion Timing column contains timing when the deletion target data is to be deleted after the deletion condition set by the staff is satisfied.

The Scheduled Deletion Time column contains time indicating when to delete the deletion target data set in the Deletion Target column.

Refer now back to FIG. 5.

The text data storage unit 13 stores therein text data.

The attached data storage unit 14 stores therein attached data.

The data deletion unit 15 performs a process of deleting deletion target data a prescribed period of time after its deletion condition is satisfied.

For example, the data deletion unit 15 deletes, from the attached data storage unit 14, blood test result data (attached data) sent from the staff of the blood diagnostic company 40 to the staff of the clinic 30 when three months pass. By doing so, the blood diagnostic company 40 is able to prevent the leakage of the blood test result data from the information management apparatus 1 after the lapse of three months.

The following describes the management screen 120.

(Management Screen)

The data processing unit 11 displays the management screen 120 illustrated in FIG. 3 on the terminal device 2a or the like in accordance with selection operations made by staff.

As illustrated in FIG. 3, the management screen 120 has a user information display area 121, a status display area 122, a summary display area 123, a document display area 124, an External Communication button 125, an Attached File button 126, a History button 127, a Memo button 128, an External Communication List display button 129, a Memo List display button 130, an information display area 131, and an information input area 132.

The user information display area 121 displays information (user information) on staff that has logged in to the information management system. Referring to FIG. 3, the user information display area 121 displays the names of a company and department to which the staff belongs, and the surname and mail address of the staff, for example.

The status display area 122 displays the number of pieces of business document data that is handled by the staff that has logged in to the information management system, for each status.

Roughly, the status display area 122 has the following folders: Inbox, Draft, Outbox, and In and Out Box.

The data processing unit 11 places business document data with the mail address of the staff designated as a recipient, into the Inbox folder.

When the staff selects the Inbox folder, the data processing unit 11 refers to the basic data management table T1. Then, the data processing unit 11 displays, in the summary display area 123, the summary of business document data that has “Order Form” in the Data Type column and “Received” in the Sent/Received column, among business document data that has “bbb@xxmail.co.jp” in the Staff Address column.

As illustrated in FIG. 3, business document data placed in the Inbox folder has the following statuses: “Unopened,” “Returning,” “Deleted by the Other Party,” “Confirmed,” and “Archive.”

The “Unopened” status is given by the data processing unit 11 to business document data that has not been confirmed by the staff among the business document data placed in the Inbox folder.

The “Returning” status is given by the data processing unit 11 to business document data that has been returned from the staff to the sender staff among the business document data placed in the Inbox folder.

The “Deleted by the Other Party” status is given by the data processing unit 11 to business document data that has been received by the staff, returned to the sender staff, and then deleted by the sender staff, among the business document data placed in the Inbox folder.

The “Confirmed” status is given by the data processing unit 11 to business document data which the staff has viewed and for which the staff has selected a Confirm button (will be described later), among the business document data placed in the Inbox folder.

The “Archive” status is given by the data processing unit 11 to business document data which the staff has saved in an archive at certain timing, among the business document data in the “Confirmed” status.

A number displayed in association with each status in the status display area 122 indicates the number of pieces of business document data in the status.

For example, the Unopened status in the status display area 122 indicates the number of pieces of business document data that have not been confirmed by the staff among received business document data.

In this connection, the Archive status in the status display area 122 does not specifically indicate any number.

When the staff would like to view the contents of business document data in a desired one of the “Unopened,” “Returning,” “Deleted by the Other Party,” “Confirmed,” and “Archive” statuses, he/she just selects the desired status in the status display area 122.

For example, when the staff selects the Unopened status, the data processing unit 11 refers to the basic data management table T1. The data processing unit 11 then displays, in the summary display area 123, the summary of the business document data having Unopened in the Status on Staff Side column among the business document data having “bbb@xxmail.co.jp” in the Staff Address column.

The data processing unit 11 places business document data that has been created and saved by the staff but has not been sent to recipient staff, in the Draft status.

The data processing unit 11 places business document data that has been sent by the staff, into the Outbox folder.

When the staff selects the Outbox folder, the data processing unit 11 refers to the basic data management table T1. The data processing unit 11 then displays, in the summary display area 123, the summary of the business document data having “Sent” in the Sent/Received column among the business document data having “bbb@xxmail.co.jp” in the Staff Address column.

As illustrated in FIG. 3, business document data placed in the Outbox folder has the following statuses: “Sent,” “Returned,” “Deleted,” and “Archive.”

The “Sent” status is given by the data processing unit 11 to business document data which has been sent to the recipient staff, among the business document data placed in the Outbox folder.

The “Returned” status is given by the data processing unit 11 to business document data that has been returned from the recipient staff, among the business document data placed in the Outbox folder. The staff is able to process the business document data returned from the recipient staff.

The “Deleted” status is given by the data processing unit 11 to business document data that has been deleted by the sender staff, among the business document data returned from the recipient staff.

The “Archive” status is given by the data processing unit 11 to business document data which the staff has saved in an archive at certain timing, among the business document data in the “Sent” status.

The Archive status in the status display area 122 does not specifically indicate any number.

What is needed to view the contents of business document data in a desired one of the “Sent,” “Returned,” “Deleted,” and “Archive” statuses is just to select the desired status.

The summary display area 123 displays the summary of business document data corresponding to a status selected by the staff in the status display area 122, as described earlier. The summary of received business document data may include the company name of a sender, a case name, a status on the sender side, and a status on the recipient side.

The same statuses are displayed on the management screens of both the staff who has sent business document data and the staff who has received the business document data.

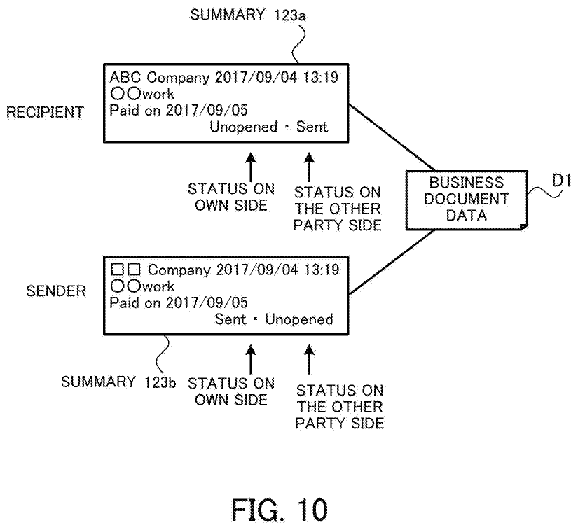

FIG. 10 is a view for explaining information to be displayed in the summary display area.

FIG. 10 illustrates a summary 123a of business document data that is displayed in the summary display area 123 of the management screen 120 viewed by recipient staff, and a summary 123b that is displayed in the summary display area 123 of the management screen 120 viewed by sender staff.

More specifically, business document data D1 with a sender of ABC company and a case name of OO work, as illustrated in FIG. 10, is in the “Sent” status in the status display area on the management screen of the terminal device operated by the sender staff. When the sender staff selects the “Sent” status in the status display area, the following information is displayed with respect to the business document data D1 in the summary display area 123: a recipient is ⊏□ company, a case name is OO work, a status on the sender staff side is “Sent,” and a status on the recipient staff side is “Unopened.”

By confirming status transitions, the sender staff is able to easily confirm the progress of processing made by the recipient staff. That is to say, the staff of both parties are able to confirm the current status of each business document data in real-time.

Refer now back to FIG. 3.

When the staff has selected the summary of business document data being displayed in the summary display area 123, the data processing unit 11 displays the contents of the business document data in the document display area 124. The contents of the document to be displayed in the document display area 124 are the same as those of existing (paper-based or PDF-based) documents, except that an address display area 124a and various buttons, which will be described later, are displayed.

In the case where the staff views business document data placed in the Inbox folder, the data processing unit 11 displays the mail address of its sender staff (from) in the address display area 124a.

In the case where the staff views business document data placed in the Draft status or Outbox folder, the data processing unit 11 displays the mail address of its recipient staff (to).

In this connection, the data processing unit 11 may display the management ID of the business document data in the document display area 124.

The staff is able to process a document being displayed in the document display area 124 on the management screen 120.

More specifically, buttons for processing the document are displayed in the document display area 124 according to the status of the business document data.

FIG. 3 illustrates a button that is displayed when confidential data in the Unopened status is selected.

The document display area 124 has a Confirm button 124b.

When the staff selects the Confirm button 124b, the data processing unit 11 refers to the basic data management table T1. The data processing unit 11 then changes the Status on Staff Side column to “confirmed” with respect to the business document data being displayed in the document display area 124. In addition, the data processing unit 11 decreases the number for the “Unopened” status by one and increases the number for the “Confirmed” status by one in the status display area 122.

Refer to FIG. 3.

Among all business document data placed in the Inbox and Outbox folders, data other than deleted business document data, business document data saved in the archive, and business document data in the Draft status is placed in the In and Out Box folder.

The following describes various buttons displayed in the management screen 120.

(External Communication Button)

When the staff selects the External Communication button 125, the data processing unit 11 switches the management screen 120 into an external communication input mode. In this external communication input mode, when the staff enters text (text data) in the information input area 132 and presses the enter key of a keyboard or the like to fix this operation, the data processing unit 11 stores, as an external communication, the text data in an external communication data storage unit (not illustrated) provided in the information management apparatus 1 in association with the mail address of the staff and the confidential data being displayed in the document display area 124. In this connection, a method of displaying such external communication is described in detail in other patent applications of the same applicant as this patent application, and is therefore not described here.

In addition, in the external communication input mode, the data processing unit 11 displays external communications created so far with respect to the business document data being displayed in the document display area 124, together with the creation dates and times in chronological order in the information display area 131.

The information display area 131 displays external communications made by both the sender staff and the recipient staff of the business document data. Therefore, this external communication input mode enables these staff to perform communications like chats with each other.

In this connection, other processing (downloading, conversion to PDF format, and others) performed by both staff on confidential data being displayed in the document display area 124 may be indicated in the information display area 131 together with the execution dates and times of the processing. This enables these staff to know the history on each other's processing.

(Attached File Button)

When the staff selects the Attached File button 126, the data processing unit 11 switches the management screen 120 into an attached file mode. In this attached file mode, when the staff clicks and drags attached data into the information input area 132 and presses the enter key of the keyboard or the like to fix this operation, the data processing unit 11 stores the attached data in the attached data storage unit 14 in association with the mail address of the staff and the business document data being displayed in the document display area 124.

In addition, in the attached file mode, the data processing unit 11 displays information on attached files attached so far with respect to the business document data being displayed in the document display area 124, in chronological order in the information display area 131. In this connection, a method of displaying such information on attached files is described in detail in other patent applications of the same applicant as this patent application, and is therefore not described here.

(History Button)

When the staff selects the History button 127, the data processing unit 11 switches the management screen 120 into a history display mode. More specifically, the data processing unit 11 displays a history about communication of business document data being displayed in the document display area 124, in chronological order in the information display area 131. In this connection, a method of displaying such a history is described in detail in other patent applications of the same applicant as this patent application, and is therefore not described here.

(Memo Button)

When the staff selects the Memo button 128, the data processing unit 11 switches the management screen 120 into a memo input mode. In this memo input mode, when the staff enters letters and so on in the information input area 132 and presses the enter key of the keyboard or the like to fix this operation and when the staff places attached data in the information input area 132 by drag and drop, the data processing unit 11 stores the letters and so on and the attached data as a memo in association with the mail address of the staff and the business document data being displayed in the document display area 124 in a memo data storage unit (not illustrated) provided in the information management apparatus 1. This memo is viewable only by the person who created the memo.

In addition, in the memo input mode, the data processing unit 11 accesses the memo data storage unit and displays memos created so far with respect to the business document data being displayed in the document display area 124, in chronological order in the information display area 131. In this connection, a method of displaying such a memo is described in detail in other patent applications of the same applicant as this patent application, and is therefore not described here.

(External Communication List Display Button)

When the staff selects the External Communication List display button 129, the data processing unit 11 refers to the external communication data storage unit storing therein data on external communications, and displays a list screen (external communication list screen) regarding external communications about documents handled by the staff in chronological order on the management screen 120. In this connection, a method of displaying such an external communication list is described in detail in other patent applications of the same applicant as this patent application, and is therefore not described here.

(Memo List Display Button)

When the staff selects the Memo List display button 130, the data processing unit 11 refers to the memo data storage unit storing therein data on external communications, and displays a list screen (memo list screen) regarding memos about documents handled by the staff in chronological order on the management screen 120. In this connection, a method of displaying such a memo list screen is described in detail in other patent applications of the same applicant as this patent application, and is therefore not described here.

The following describes a management screen for processing invoice data.

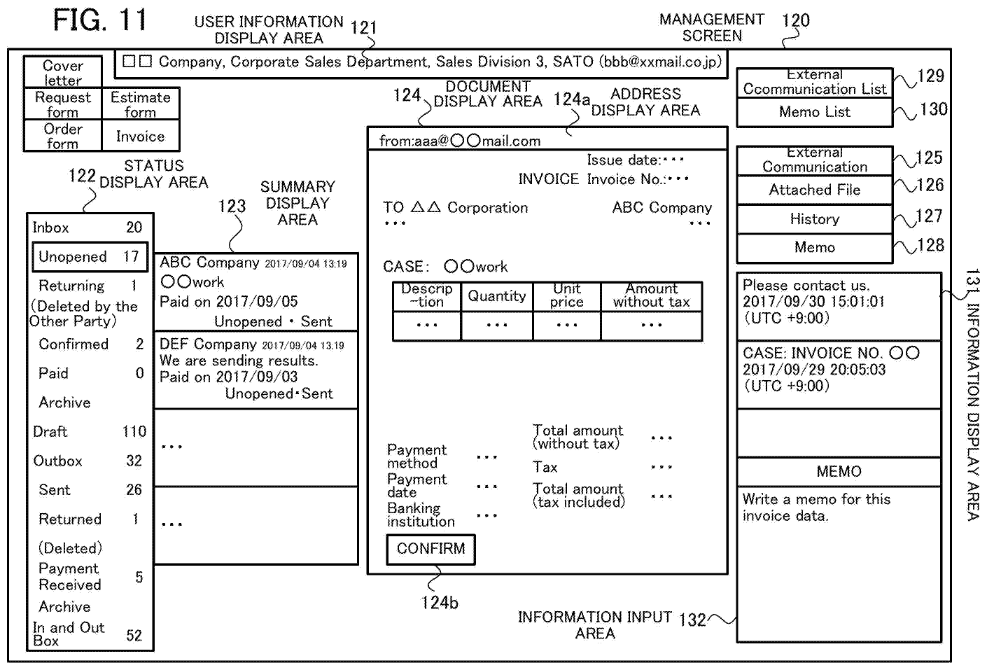

FIG. 11 is a view for explaining another example of a screen that is displayed on the terminal device.

Different features from the management screen of FIG. 3 will be described and the same features are not described here.

As illustrated in FIG. 11, the Inbox folder further has a “Paid” status for processing invoice data.

The “Paid” status is given by the data processing unit 11 to invoice data for which staff has made payment and then selected a Payment button (not illustrated) displayed in the document display area 124, among the invoice data placed in the Inbox folder.

The staff is able to compile invoice data in the Paid status to confirm the details of the payment.

In addition, the Outbox folder further has a “Payment Received” status for processing invoice data.

The “Payment Received” status is given by the data processing unit 11 to invoice data for which the biller staff has confirmed payment and selected a Payment Received button (not illustrated) displayed in the document display area 124, among the invoice data placed in the Outbox folder.

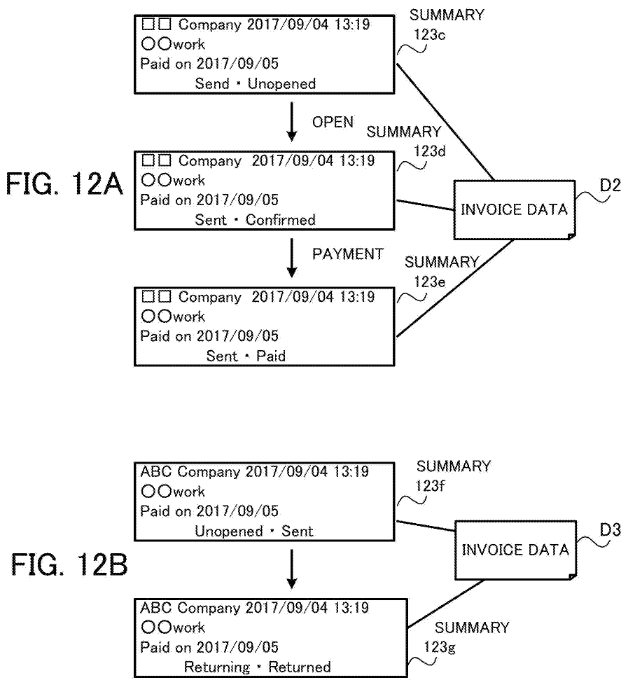

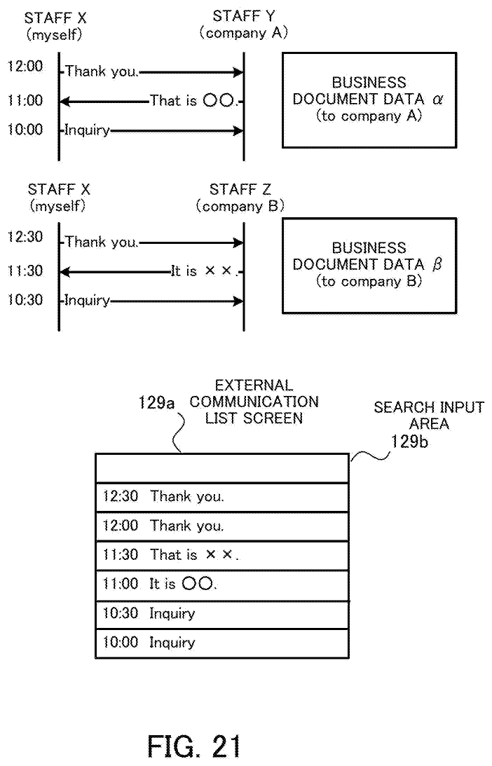

FIGS. 12A and 21B are views for explaining information on communication of invoice data, which is displayed in the summary display area.

FIG. 12A illustrates summaries 123c, 123d, and 123e, all of which are of invoice data D2.

When bill-to party staff has viewed the invoice data D2 and selected the Confirm button 124b displayed in the document display area 124, the data processing unit 11 changes information displayed in the summary display area 123 from the summary 123c to the summary 123d on the management screen 120 of the terminal device operated by biller staff (that is, change from “unopened” to “confirmed”).

After that, when the bill-to party staff has made payment for the invoice data D2 and selected a Paid button (not illustrated) displayed in the document display area 124, the data processing unit 11 changes the information displayed in the summary display area 123 from the summary 123d to the summary 123e on the management screen 120 of the terminal device operated by the biller staff.

As another example, FIG. 12B illustrates summaries 123f and 123g, both of which are of invoice data D3.

When the bill-to party staff has viewed the invoice data D3 and selected a Return button (not illustrated) displayed in the document display area 124, the data processing unit 11 changes information displayed in the summary display area 123 from the summary 123f to the summary 123g on the management screen of the terminal device operated by the bill-to party staff.

The following describes an example of how to create confidential data.

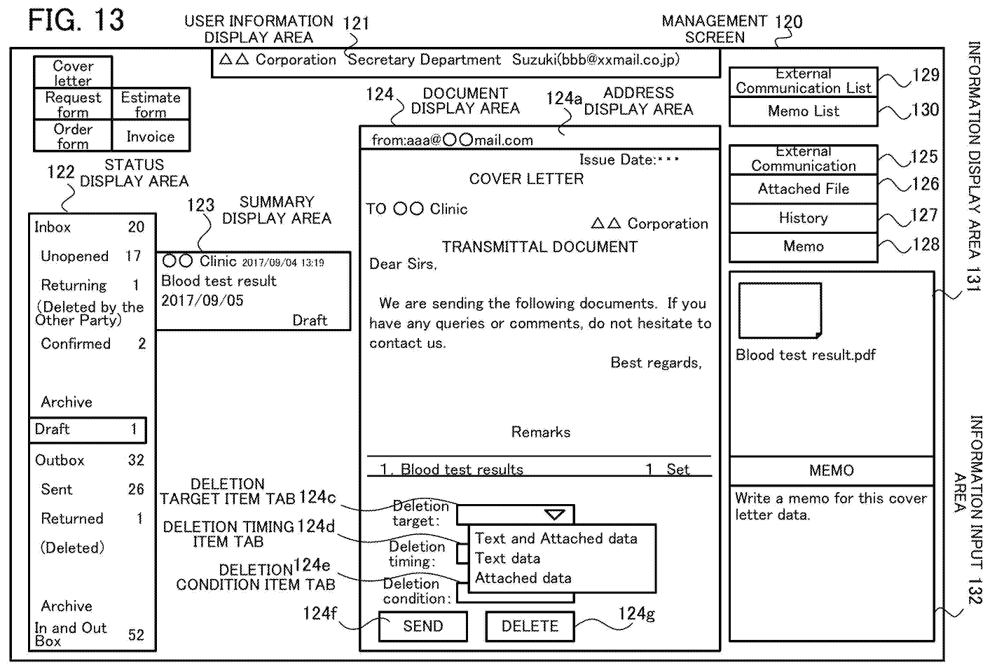

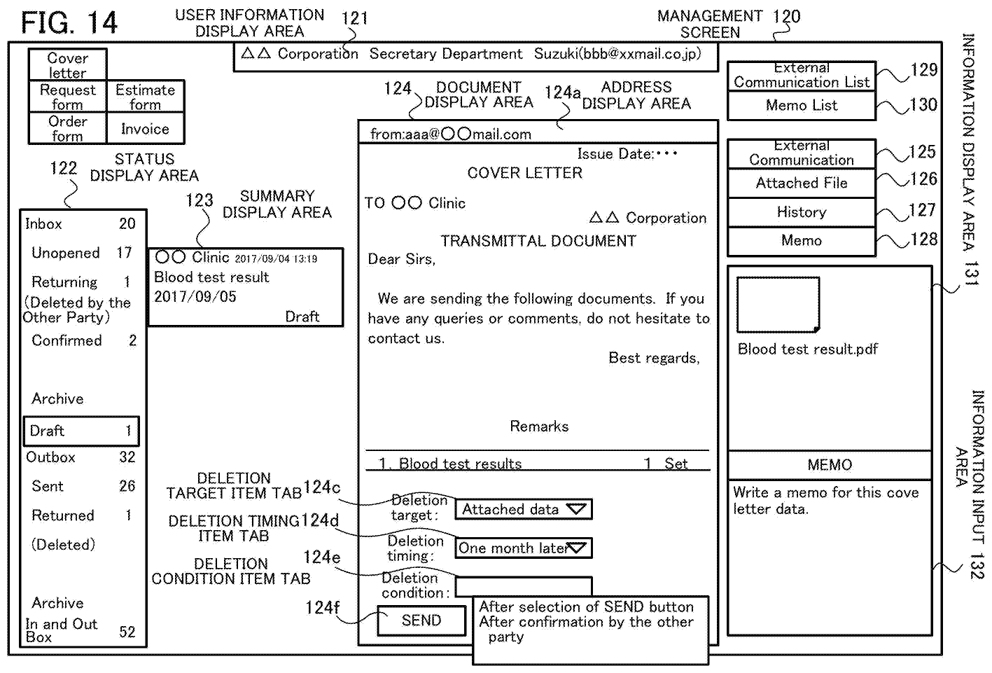

FIGS. 13 and 14 are views for explaining how the data deletion unit operates.

The document display area 124 of the management screen 120 illustrated in FIG. 13 has a deletion target item tab 124c, a deletion timing item tab 124d, and a deletion condition item tab 124e.

The staff of the blood diagnostic company 40 selects these tabs to designate deletion target data in business document data, thereby creating confidential data.

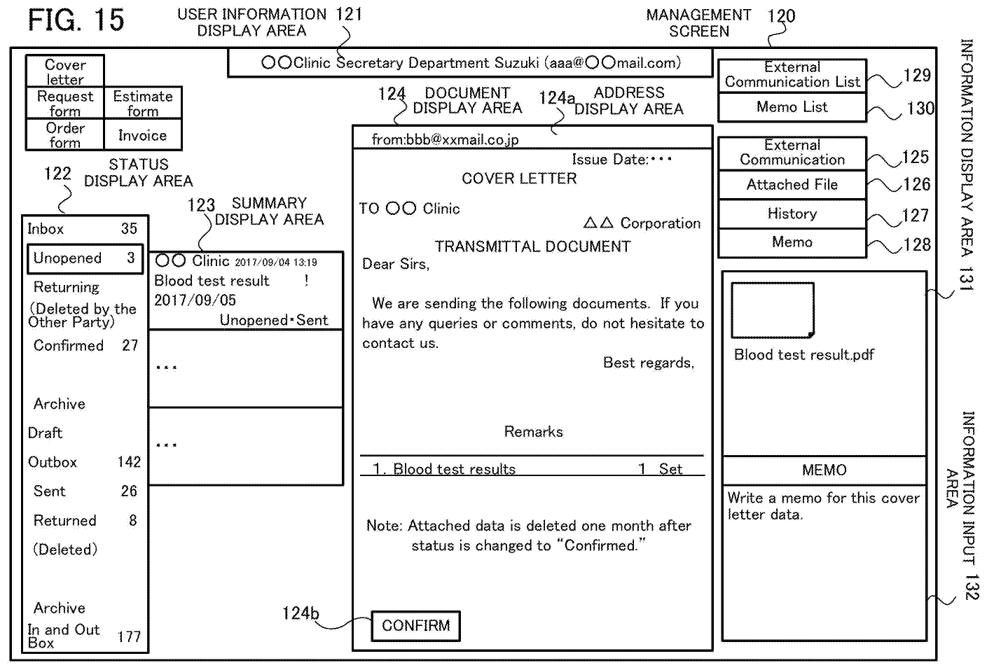

More specifically, the staff of the blood diagnostic company 40 selects the deletion target item tab 124c to select which data in business document data is designated as data to be deleted (deletion target data). More specifically, the staff of the blood diagnostic company 40 is able to select one of deletion of text data (the text of cover letter data in FIG. 15), deletion of text data and attached data, and deletion of attached data only. In this connection, in the case where a plurality of pieces of attached data exist, these pieces of attached data may individually be set as a deletion target.

In addition, the staff of the blood diagnostic company 40 selects the deletion timing item tab 124d to select when to delete the selected deletion target items. Such deletion timing may be set for each piece of data. For example, the following setting may be made: attached data is to be deleted one month after a trigger, whereas text data is to be deleted two months after the trigger.

Alternatively, the following setting may be made: part of text data is to be deleted one month after a trigger, and the other part of the text data is to be deleted two months after the trigger.

In addition, as illustrated in FIG. 14, the staff of the blood diagnostic company 40 selects the deletion condition item tab 124e to define an action condition (trigger) for setting scheduled deletion time of the deletion target data. More specifically, the staff of the blood diagnostic company 40 is able to define that the deletion target data is to be deleted when the deletion timing comes after selection of a Send button (to be described later). As another example, the staff of the blood diagnostic company 40 is able to define that the deletion target data is to be deleted when the deletion timing comes after the recipient staff views the business document data including the deletion target data, selects the Confirm button 124b displayed in the document display area 124 and thereby the data processing unit 11 changes the Status on the Other Party Side column from “Unopened” to “Confirmed” in the basic data management table T1.

As yet another example, the staff of the blood diagnostic company 40 is able to define that deletion target data is to be deleted when the deletion timing comes after the data deletion unit 15 confirms downloading of attached file attached to the business document data. Alternatively, the staff is able to select a desired time point to delete the deletion target data, such as when the recipient staff logs in to the information management system or when the recipient staff receives new business document data.

In this connection, in the case where a plurality of attached data exists, deletion timing and deletion condition may be selected for each individual attached data. In addition, in the case where a plurality of pieces of attached data is attached to one piece of text data, the following setting may be made: one piece of the attached data is designated as a deletion target, and the others of the attached data are not designated as deletion targets.

The staff of the blood diagnostic company 40 selects a Send button 124f after selecting deletion targets, deletion timing, and deletion condition. Thereby, the data processing unit 11 sets a new record based on the selected information in the deletion data management table T4.

In this connection, in the present embodiment, deletion targets, deletion timing, and deletion condition are selected from the pulldown lists. Alternatively, these may manually be set using a keyboard.

In this embodiment, it is assumed that the staff of the blood diagnostic company 40 selects each item tab so that blood test result data attached to cover letter data is to be deleted one month after the staff of the clinic 30 opens the cover letter.

FIG. 15 is a view for explaining a management screen that is viewed by the staff of the clinic.

After the staff of the blood diagnostic company 40 selects the Send button 124f, the staff of the clinic 30 is able to view the cover letter data by selecting the “Unopened” status in the status display area 122 of the viewable management screen 120.

The data processing unit 11 monitors the Status on the Other Party Side column in the basic data management table T1. When the staff of the clinic 30 selects a Confirm button 124b, the data processing unit 11 sets a scheduled deletion time in the Scheduled Deletion Time column in the deletion data management table T4, taking a change of the status of the cover letter data to “Confirmed” as a trigger.

The data deletion unit 15 monitors the deletion data management table T4, and then deletes the deletion target data when its scheduled deletion time comes.

The following describes a process that is performed in creation of confidential data with reference to a flowchart.

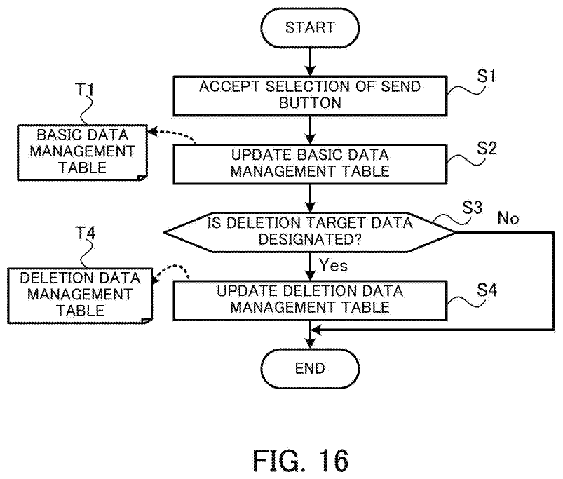

FIG. 16 is a flowchart illustrating a process that is performed in creation of confidential data.

(Step S1) The data processing unit 11 accepts selection of the Send button 124f. Then, the process proceeds to step S2.

(Step S2) The data processing unit 11 updates the basic data management table T1. More specifically, the data processing unit 11 sets a management ID for newly created business document data, and also adds, to the basic data management table T1, basic data indicating “Sent” for the Sent/Received column, the date and time of acceptance of the selection of the Send button for the Sent/Received Date and Time column, “Sent” for the Status on Staff Side, and “Unopened” for the Status on the Other Party Side. In addition, the data processing unit 11 adds existence or absence of deletion target data to the basic data. Then, the process proceeds to step S3.

(Step S3) The data processing unit 11 determines whether deletion target data is designated in the created business document data. If deletion target data is designated (Yes in step S3), the process proceeds to step S4. If no deletion target data is designated (No in step S3), then the process of FIG. 16 is completed.

(Step S4) The data processing unit 11 updates the deletion data management table T4. More specifically, the data processing unit 11 adds, to the deletion data management table T4, a record including the management ID, data type, and deletion target with respect to the newly created confidential data. In the case where “after selection of Send button” is set as a deletion condition, a scheduled deletion time is set. In the case where “after confirmation by the other party”, nothing is set as the scheduled deletion time. Then, the process of FIG. 16 is completed.

The data processing unit 11 performs the following process when an action that satisfies a deletion condition is taken, such as when the Send button 124f is selected or when the Confirm button 124b is selected.

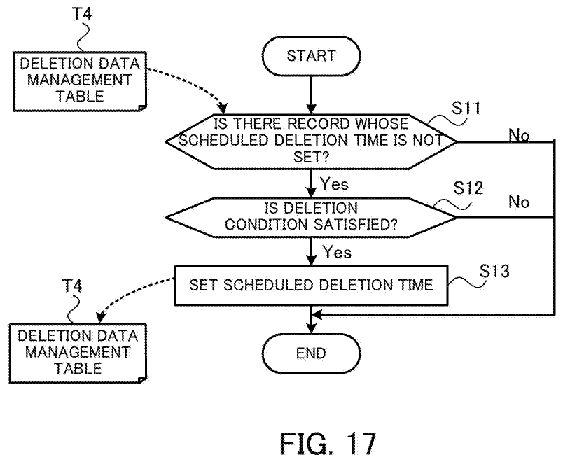

FIG. 17 is a flowchart illustrating a process of managing deletion data.

(Step S11) The data processing unit 11 refers to the deletion data management table T4 to determine whether there is a record with a blank (unset) in the Scheduled Deletion Time column. If such a record is found (Yes in step S11), the process proceeds to step S12. If there is no such a record (No in step S11), the process of FIG. 17 is completed.

(Step S12) The data processing unit 11 determines with respect to the found record whether an executed action satisfies the deletion condition defined in the deletion data management table T4. If the executed action satisfies the deletion condition defined in the deletion data management table T4 (Yes in step S12), the process proceeds to step S13. If the executed action does not satisfy the deletion condition defined in the deletion data management table T4 (No in step S12), the process of FIG. 17 is completed.

(Step S13) The data processing unit 11 refers to the Deletion Timing column to set a scheduled deletion time in the Scheduled Deletion Time column of the record in question. For example, in the case where the deletion condition is satisfied at 14:40:46 on Feb. 21, 2017 and the deletion timing of “one month later” is defined, then the time, 14:40:46 on Mar. 21, 2017, is set in the Scheduled Deletion Time column. Then, the process of FIG. 17 is completed.

The following describes a process that is performed in deletion of data with reference to a flowchart.

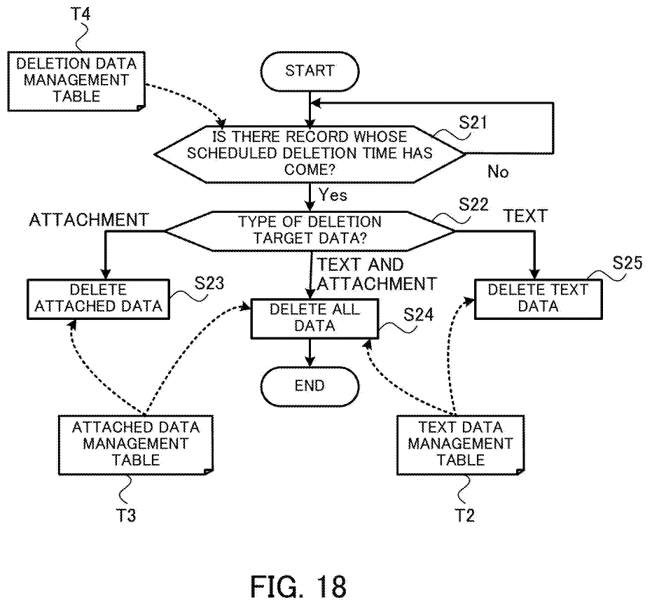

FIG. 18 is a flowchart illustrating a process that is performed in deletion of data.

(Step S21) The data deletion unit 15 refers to the deletion data management table T4 to determine whether there is a record whose scheduled deletion time has come. If such a record is found (Yes in step S21), the process proceeds to step S22. If no such a record is found (No in step S21), the process stays at step S21.

(Step S22) The data deletion unit 15 refers to the Deletion Target column of the found record in the deletion data management table T4. If the type of the deletion target data is attached data (Attachment in step S22), the process proceeds to step S23. If the type of deletion target data is all data (Text and Attachment), the process proceeds to step S24. If the type of deletion target data is text data (Text in step S22), the process proceeds to step S25.

(Step S23) The data deletion unit 15 refers to the attached data management table T3 to specify attached data corresponding to the same management ID as indicated in the found record and deletes the specified attached data from the information management apparatus 1. Thereby, each staff who is able to log in to the information management apparatus 1 is no longer allowed to access the attached data. Then, the process of FIG. 18 is completed.

(Step S24) The data deletion unit 15 refers to the attached data management table T3 to specify the attached data corresponding to the same management ID as indicated in the found record and deletes the specified attached data from the information management apparatus 1. In addition, the data deletion unit 15 refers to the text data management table T2 and deletes text data corresponding to the same management ID as indicated in the found record. Thereby, each staff who is able to log in to the information management apparatus 1 is no longer allowed to access the text data or the attached data. Then, the process of FIG. 18 is completed.

(Step S25) The data deletion unit 15 refers to the text data management table T2 to specify the text data corresponding to the same management ID as indicated in the found record and deletes the specified text data from the information management apparatus 1. Thereby, each staff who is able to log in to the information management apparatus 1 is no longer allowed to access the text data. Then, the process of FIG. 18 is completed.

In this connection, a prescribed message, “the data has been deleted,” may be displayed for data that is no longer accessible on the management screen 120.

As described above, the information management system 10 is provided with the basic data management table T1 in which, when confidential data sent from the terminal device 2c to the staff of the clinic 30 is received over the network 50, the received business document data is stored in association with the mail address of the staff of the clinic 30 and the staff of the blood diagnostic company 40, the deletion data management table T4 that contains a condition for making at least partial data of the business document data inaccessible to the staff of the clinic 30, and the data processing unit 11 that performs a process of making at least the partial data of the business document data inaccessible to the staff of the clinic 30 when the staff of the clinic 30 takes an action defined in the action condition preset by the staff of the blood diagnostic company 40. This approach simplifies management of confidential data and reduces a risk of information leakage.

In addition, confidential data is not communicated directly between the terminal devices 2a, 2b, and 2c. All confidential data created using the terminal devices 2a, 2b, and 2c and sent to recipients is held by the information management apparatus 1 and is treated like shared data. Therefore, the staff of the recipients are able to obtain original documents by printing out the confidential data.

In addition, electronic signature processing, timestamp processing, and other processing are not needed, thereby making it possible to save labor for converting paper-based documents to PDF files for tax inquiry.

Information on confidential data is stored in the basic data management table T1 when the confidential data is sent, and the statuses of subsequent transactions are managed using this basic data management table T1. Therefore, the staff are able to get away from manually compiling documents into a data sheet.

In this connection, the above embodiment has described the case where deletion target data is actually deleted. However, in addition to this configuration, the information management apparatus 1 may be designed such as to keep the deletion target data without deleting it and to prohibit staff from accessing the deletion target data. By allowing the administrator of the information management apparatus 1 to access the deletion target data, it becomes possible to reduce the risk of completely deleting the deletion target data from this world.

In addition, the above embodiment has described the case where the staff is able to set a deletion target item and deletion timing. In addition to this configuration, deletion target items the staff is able to set may be limited according to his/her authority level. For example, the staff is allowed to set deletion of attached data only but is not allowed to set deletion of text data. In addition, supervisors of the staff may be allowed to set deletion of both attached data and text data.

Further, the above embodiment has described the case where all text is deleted. In addition to this configuration, a range of data to be deleted, such as only part of text (for example, only data indicating an amount of money in an invoice), may be desirably designated.

Still further, the above embodiment has exemplified text data and attached data as deletion target data. Alternatively, the deletion target data is not limited thereto, and various kinds of data, such as external communication data between staff and memo data created by the staff, may be designated as the deletion target data.

Still further, the above embodiment has described the case where both text data and attached data are deleted at the same time when their scheduled deletion time comes, in the case where deletion of the text data and attached data is selected. However, in addition to this configuration, these deletion target data may be deleted at different deletion times.

By the way, in the above embodiment, the data deletion unit 15 may be designed to perform a process of changing deletion timing according to a request from staff, for confidential data whose deletion condition is already satisfied and so whose scheduled deletion time is already set (i.e., a process of pausing a timer that counts the scheduled deletion time), so as to put off the scheduled deletion time.

Alternatively, the staff who has sent confidential data may be allowed to change its scheduled deletion time that is already set.

The following describes modification examples.

### MODIFICATION EXAMPLE 1

In the embodiment, the sender staff determines deletion targets, deletion timing, and deletion condition with respect to deletion target data. Alternatively, the recipient staff may determine the deletion targets, deletion timing, and deletion condition with respect to the deletion target data.

If both the sender staff and the recipient staff set different scheduled deletion times, one of the scheduled deletion times, whichever comes earlier, may be set in the Scheduled Deletion Time column in the deletion data management table T4. The following describes an example.

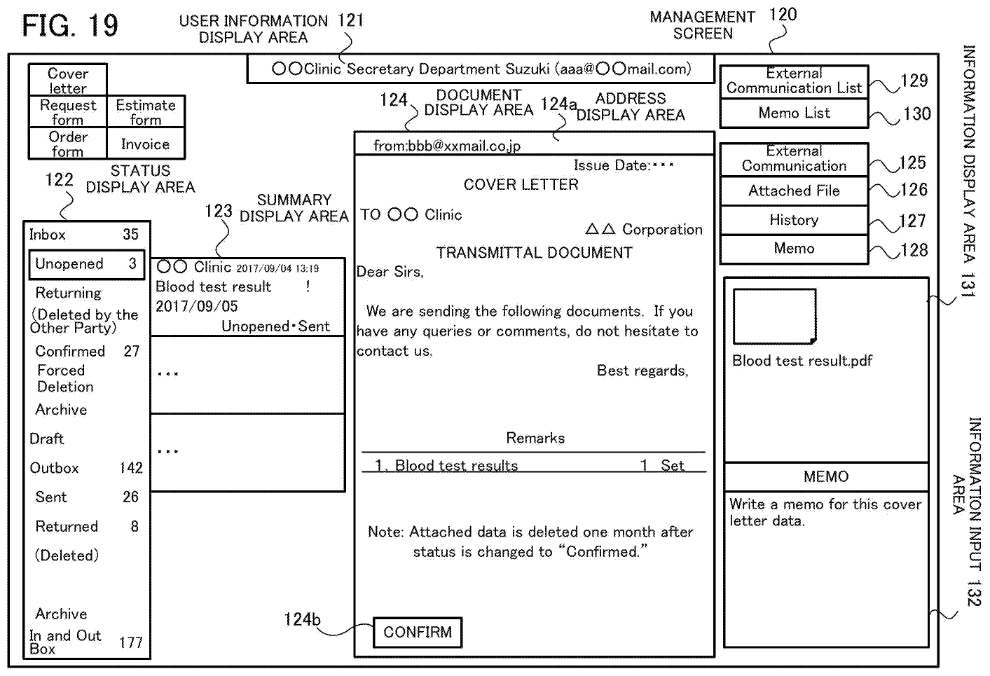

FIG. 19 is a view for explaining a management screen that is viewed by the staff of the clinic according to a modification example.

A management screen 120 in this modification example has a “Forced Deletion” status in a status display area 122. After the recipient staff confirms the contents of confidential data in the Unopened status and places the confidential data in the Forced Deletion status, the data processing unit 11 changes the status of the corresponding deletion target data to “Forced Deletion.” When the status of the deletion target data is changed to “Forced Deletion,” the data deletion unit 15 deletes the deletion target data, irrespective of the deletion timing set by the sender. Alternatively, the deletion target data may be deleted according to the time preset for the Forced Deletion status.

Alternatively, words in the text of external communications are extracted and then deletion timing may be set.

The following describes another modification example.

### MODIFICATION EXAMPLE 2

The modification example 2 describes an example of deleting deletion target data using an external communication list.

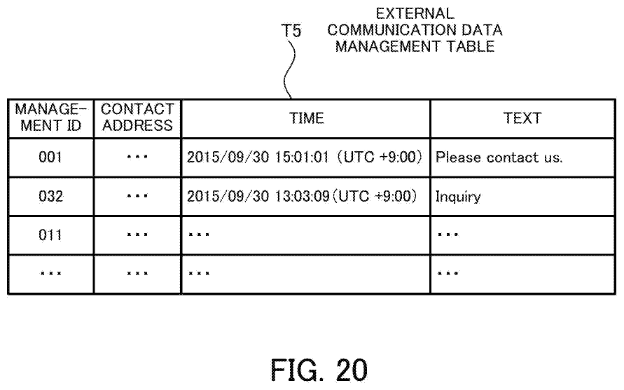

FIG. 20 is a view for explaining an example of external communication data.

In the present embodiment, external communication data is recorded in tabular form.

An external communication data management table T5 has the following columns: Management ID, Contact Address, Time, and Text. Information pieces arranged in a horizontal direction are associated with each other.

The Management ID column contains the management ID of business document data (business document data associated with external communication data) that was displayed in the document display area 124 when the staff created the external communication data.

The Contact Address column contains the mail address of the staff who has created the external communication data.

The Time column contains the creation date and time of the external communication data.

The Text column contains the content of the external communication.

In the external communication input mode, the data processing unit 11 refers to the external communication data management table T5 with respect to the text data being displayed in the document display area 124, and displays external communications created so far, together with their creation dates and times in chronological order in the information display area 131.

The information display area 131 displays external communications entered by both the sender staff and the recipient staff of the business document data. Therefore, this external communication input mode enables these staff to perform communications like chats with each other.

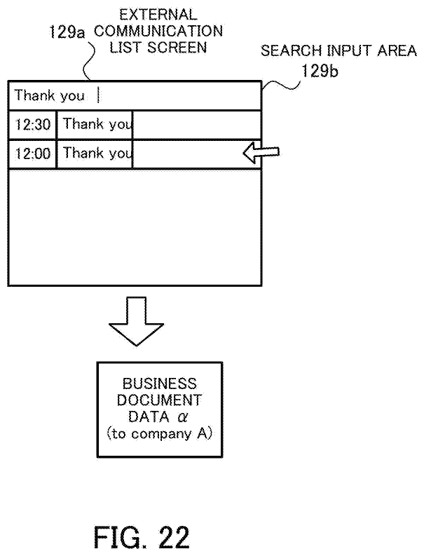

FIGS. 21 and 22 are views for explaining examples of an external communication list.

As illustrated in FIG. 21, assume that staff X made external communications with staff Y with regard to business document data α at 10:00, 11:00, and 12:00 on the same day, and the staff X made external communications with staff Z with regard to business document data β at 10:30, 11:30, and 12:30 on the same day.

In this case, an external communication list screen 129a as illustrated in FIG. 21 is displayed on the management screen 120 of the terminal device operated by the staff X. This external communication list screen 129a displays logs about external communications with other staff in chronological order, not for each business document data.

This external communication list screen 129a has a search input area 129b. When the staff X enters a search word and presses an enter key (search request), the data processing unit 11 identifies external communications including text matching the search word.

For example, as illustrated in FIG. 22, when the staff X enters “Thank you” in the search input area 129b and presses the enter key, the data processing unit 11 displays “Thank you” at 12:00 and “Thank you” at 12:30 as a search result. For example, when the staff X selects and clicks on “Thank you” at 12:00, the data processing unit 11 displays the contents of the business document data α associated with the external communication data including the text in question, in the document display area 124.

In this way, desired business document data is easily found on the basis of words used in external communications.

In this connection, without entering a search word in the search input area 129b, the staff may directly click on desired text on the external communication list screen 129a. This operation also causes the data processing unit 11 to display the contents of business document data associated with external communication data including the text in question in the document display area 124.

The above external communication method enables the staff to easily change the deletion time for deletion target data afterwards.

For example, assume the case where the sender staff sends the recipient staff an external communication saying “Please delete the attached blood test results five hours later because a different staff name is indicated.” In this case, the data processing unit 11 determines, based on the following keywords, “blood test results,” “five hours later,” and “delete,” from the external communication that the scheduled deletion time for the business document data needs to be changed. Then, the data processing unit 11 specifies the deletion target data (a file “blood test result.pdf” in this embodiment) on the basis of the management ID associated with the business document data. Then, the data processing unit 11 refers to the deletion data management table T4 to set (overwrite) the scheduled deletion time for the specified deletion target data to the time that is five hours after the receipt of the external communication. In the way described above, the sender staff is able to easily change the deletion time afterwards, even after the deletion time is already set for the deletion target data. In addition, the sender staff is able to change the deletion time for the deletion target data by only sending an external communication.

In this connection, the modification example 2 has described the example of changing the deletion time afterwards. In addition to this configuration, for example, a range of data to be deleted in the deletion target data may be changed based on an external communication.

By the way, processing performed by the information management apparatus 1 may be performed by a plurality of apparatuses in a distributed manner.

In addition, in the embodiment, the information management apparatus 1 has various storage units including the confidential data storage unit 13. Alternatively, each storage unit may be provided at a different location from the data processing unit 11 in cloud-based platform.

Heretofore, the information processing apparatus and information processing method of the embodiment have been described. These are not limited thereto, and the components of each unit may be replaced with other components having equivalent functions or other components. In addition, other desired configurations and steps may be added to the embodiment.

The above-described processing functions may be implemented by using a computer. In this case, a program is prepared, which describes processes for the functions of the information management apparatus 1. A computer implements the above-described processing functions by executing the program. The program describing the intended processes may be recorded on a computer-readable recording medium. Computer-readable recording media include magnetic storage devices, optical discs, magneto-optical recording media, and semiconductor memories. The magnetic storage devices include HDDs, flexible disks (FDs), and magnetic tapes. The optical discs include DVDs, DVD-RAMs, CD-ROMs, and CD-RWs. The magneto-optical recording media include magneto-optical disks (MOs).

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer over a network, the computer may sequentially run this program.

In addition, the above-described processing functions may also be implemented wholly or partly by using a digital signal processor (DSP), an application-specific integrated circuit (ASIC), a programmable logic device (PLD), or other electronic circuits.

According to one aspect, management of confidential data is simplified.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information management apparatus, comprising:
a first memory configured to store therein, upon receipt of business document data sent from a terminal device to a specified recipient over a network, the received business document data in association with identification information of the recipient and identification information of a sender of the business document data;
a second memory configured to store therein a condition for making at least partial data of the business document data inaccessible to the recipient; and
a processor configured to perform a process of making the at least partial data of the business document data inaccessible to the recipient upon detecting that the sender or the recipient has taken an action defined in the condition set in the second memory, wherein
the sender and the recipient are able to individually set prescribed time, and
the processor performs the process at the prescribed time set by the sender or the prescribed time set by the recipient, whichever comes earlier.

2. The information management apparatus according to claim 1, wherein:
the condition includes information on the prescribed time to make the at least partial data inaccessible; and
the processor performs the process at the prescribed time.

3. The information management apparatus according to claim 2, wherein the processor performs another process of changing the prescribed time, based on text included in a history about communication between the recipient and the sender.

4. The information management apparatus according to claim 1, wherein:
the condition includes information on target data that is to be made inaccessible in the business document data; and
the processor performs the process so as to make only the target data inaccessible.

5. A data processing method executed by a computer including a first memory that is configured to store therein, upon receipt of business document data sent from a terminal device to a specified recipient over a network, the received business document data in association with identification information of the recipient and identification information of a sender of the business document data, the data processing method comprising:
making at least partial data of the business document data inaccessible to the recipient upon detecting that the sender or the recipient has taken an action defined in a condition for making the at least partial data of the business document data inaccessible to the recipient, the condition being stored in a second memory, wherein
the sender and the recipient are able to individually set prescribed time, and
the making includes making the at least partial data of the business document data inaccessible at the prescribed time set by the sender or the prescribed time set by the recipient, whichever comes earlier.

6. A non-transitory computer-readable recording medium storing a computer program that causes a computer, which includes a first memory that is configured to store therein, upon receipt of business document data sent from a terminal device to a specified recipient over a network, the received business document data in association with identification information of the recipient and identification information of a sender of the business document data, to perform a process comprising:
making at least partial data of the business document data inaccessible to the recipient upon detecting that the sender or the recipient has taken an action defined in a condition for making the at least partial data of the business document data inaccessible to the recipient, the condition being stored in a second memory, wherein
the sender and the recipient are able to individually set prescribed time, and
the making includes making the at least partial data of the business document data inaccessible at the prescribed time set by the sender or the prescribed time set by the recipient, whichever comes earlier.
